(19) United States
(12) Patent Application Publication
(10) Pub. No.: US 2014/0097182 A1
(43) Pub. Date: Apr. 10, 2014

(54) INTERMODAL CONTAINER HAVING A RESILIENT LINER

(71) Applicant: SANDCAN INC., San Antonio, TX (US)

(72) Inventor: John M. Sheesley, San Antonio, TX (US)

(73) Assignee: SANDCAN INC., San Antonio, TX (US)

(21) Appl. No.: 13/648,939

(22) Filed: Oct. 10, 2012

(51) Int. Cl. B65D 88/00; B23P 17/00

(52) U.S. Cl. 220/1.6; 29/401.1

(57) ABSTRACT

An intermodal container is modified to carry a fracing proppant such as sand from a quarry or source to the frac site. An upper hatch is formed at the top of the intermodal container and a lower hatch is formed in the bottom of the intermodal container. Hydraulically operating sliding gates are placed under the top and bottom hatches. A resilient liner having a bladder extends from the upper hatch to the lower hatch. The bladder expands during loading to receive the proppant therein and contracts when unloading to expel the proppant from the intermodal container.

### CROSS-REFERENCE TO RELATED APPLICATIONS

This is an improvement patent application over U.S. patent application Ser. No. 13/370,401, filed on Feb. 10, 2012, entitled “Method and Apparatus for Modifying a Cargo Container to Deliver Frac Sand to a Frac Site”, which application has the same inventor and assignee and is incorporated herein by reference.

### BACKGROUND OF THE INVENTION

1. Field of the Invention

This invention relates to the modification of an intermodal container for the transportation of a granular substance such as sand and, more particularly, the insertion of a resilient liner between a top opening and a bottom opening of a cargo container.

2. Description of the Prior Art

An intermodal container (also called cargo container, freight container, ISO container, shipping container, High-Q container, Sea Cans) is a standardized reusable steel box used for the safe, efficient and secure storage and movement of materials and products within a local containerized freight transportation system. The container can be moved from one mode of transportation to another without unloading and reloading the contents of the container. All of the containers are 8 ft. wide or 8 ft.-6 in. wide so they can travel along standard highway systems, but the height and width may vary to some degree. The length of the standard intermodal container is either 20 ft., 40 ft., 45 ft. or 53 ft. The height of the intermodal container is normally 8 ft., 6 in., but a “High Q” container can be 9 ft. 6 in. in height.

A general purpose intermodal container has doors fitted on one end and is constructed of corrugated weathering steel. The intermodal containers can be stacked up to seven containers high. At each corner are castings with openings for twist-lock fasteners to hold the containers in position. There are millions of intermodal containers available worldwide.

In the last few years, hydraulic fracturing (also known as fracing) has been used in gas/oil wells to create cracks in the underground reservoir. The cracks create other passages for the oil/gas to flow there through, which increases the recovery of the fossil fuels. To keep the fractures from closing once pressure is released, a proppant is carried by the fracing fluid into the cracks. When the pressure is released, the proppant will keep the cracks open for further recovery of oil/gas. The most common proppant used is sand, although in recent years, other proppants, such as resin-coated or ceramic sand have been utilized.

To get the proppant such as sand to the well site may require a number of different modes of transportation. For example, in deep wells in South Texas, the good quality fracing sand comes from places such as the States of Wisconsin and Illinois or countries such as China. If the proppant comes from other countries, it is typically delivered to the United States by ship and is handled at multiple locations in multiple ways that is very inefficient for supply chain logistics. The more the fracing proppant is handled, the more expensive it is to the individual fracing company as well as the well operator.

As the incorporated patent application Ser. No. 13/370,401 shows, cargo containers (intermodal containers) can be modified to carry fracing sand or any other proppant. The intermodal container will need an upper hatch for inserting the proppant into the intermodal container and a lower hatch for removing the proppant from the intermodal container. However, a considerable amount of modification is necessary inside the intermodal container to get all of the proppant in and out of the intermodal container when loading and emptying. Some type of hopper with downwardly sloping inner surfaces to the lower hatch is necessary to completely empty the intermodal container. The slope of the inner surfaces of the hopper has to be sufficiently steep so that the proppant will flow out of the intermodal container through the lower hatch.

The upper hatch and the lower hatch should be closed during transportation. While other types of closure mechanisms may be used, the incorporated reference shows the use of sliding doors to close the upper hatch and the lower hatch, which sliding doors are operated by hydraulic cylinders, or manually, pneumatically, or electrically operated.

If the hopper inside of the intermodal container can be eliminated so that only an upper hatch and a lower hatch with sliding doors is used for the insertion or removal of the proppant, and with a resilient liner there between, the cost of the modification of the intermodal container can greatly be reduced.

### SUMMARY OF THE INVENTION

It is an object of the present invention to modify intermodal containers for delivery of granular material.

It is another object of the present invention to modify an intermodal container to have a resilient liner therein for containing the granular material.

It is still another object of the present invention to modify an intermodal container so that sand can be loaded into the intermodal container through a hatch in the top and removed from the intermodal container through a hatch in the bottom.

It is still another object of the intermodal container to provide a resilient liner between a top hatch and a bottom hatch of an intermodal container so that the resilient liner will tend to resume its original shape and force the granular material out of the bottom hatch when opened.

An intermodal container that is 8 ft.×8 ft. 6 in.×20 ft. can be modified to carry a proppant, such as fracing sand. A hole is cut in the top and bottom of the intermodal container to form an upper hatch and a lower hatch, respectively. Each of the hatches may be closed by a suitable closure device such as a sliding door.

Located between the upper hatch and the lower hatch, and securely attached on each end thereto, is a resilient liner that extends vertically from the upper hatch to the lower hatch. When the upper hatch is open and proppant such as sand inserted therein, if the lower hatch is closed, the proppant will begin to accumulate inside the resilient liner. The weight of the column of proppant will cause the resilient liner to extend outward in a balloon-like fashion. Continued insertion of the proppant (i.e., sand) through the upper hatch into the resilient liner will cause the resilient liner to expand outward until essentially the entire intermodal container is filled with the proppant inside the resilient liner. The only vacant space will be around the outer top portion of the intermodal container as determined by the angle of repose of the proppant. Thereafter, the intermodal container filled with the proppant can be shipped to the desired location for unloading.

At the desired location for unloading, such as a frac site, the lower hatch is opened to allow the proppant to flow from the intermodal container. This is typically done when the intermodal container is lifted above a device known as a Sand King, which Sand King accumulates the proppant for insertion into the well during the fracing process.

By opening the lower hatch, proppant such as sand will flow from the inside of the resilient liner within the intermodal container until the proppant reaches the angle of repose of the proppant. For dry sand, the angle of repose is approximately 34°.

As the angle of repose is approached by the proppant, the resiliency of the resilient liner causes the resilient liner to return to its original configuration. The returning of the resilient liner to its original configuration moves more of the proppant towards the center of the resilient liner. The movement allows additional proppant to flow from the resilient liner through the lower hatch. By having enough resiliency in the internal liner to resume its original shape, all of the proppant is forced towards the middle where the proppant then flows through the lower hatch. The resiliency of the resilient liner must be strong enough to cause the inner liner to return to its original shape as proppant is removed therefrom.

### DESCRIPTION OF THE DRAWINGS

FIG. 1 is a perspective view of a resilient liner for insertion between an upper hatch and a lower hatch of an intermodal container.

FIG. 2 is a partial cross-sectional view of an intermodal container with a resilient liner inserted therein.

FIG. 3 is a partial cross-sectional view of an intermodal container with a resilient liner partially filled with proppant inserted therein, which proppant is being unloaded.

### DESCRIPTION OF THE PREFERRED EMBODIMENT

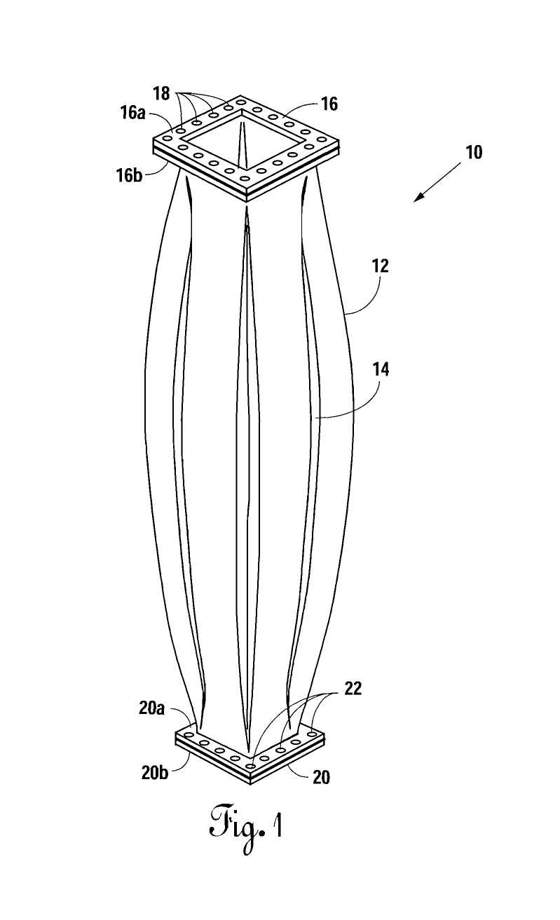

Referring to the incorporated patent application Ser. No. 13/370,401, filed on Feb. 10, 2012, a “Method And Apparatus For Modifying A Cargo Container To Deliver Frac Sand To A Frac Site” is shown and described. The present invention shows another way to modify the cargo container (intermodal container) to deliver a proppant (such as frac sand) to a frac site. Referring to FIG. 1, there is shown a resilient liner represented generally be reference numeral 10 that is long enough to reach from the top to the bottom of an intermodal container. The resilient liner 10 has a bladder 12 that has folds 14 therein for expansion if necessary. At the top of the bladder 12 is a upper mounting bracket 16 with mounting holes 18 there around. The bladder 12 is clamped between an upper portion 16a and a lower portion 16b of upper mounting bracket 16.

At the bottom of the bladder 12 is a lower mounting bracket 20 with mounting holes 22 therein. The bladder 12 is clamped between an upper portion 20a and a lower portion 20b of lower mounting bracket 20. The bladder 12 is formed from a resilient material such as rubber so that it always tends to resume its original shape.

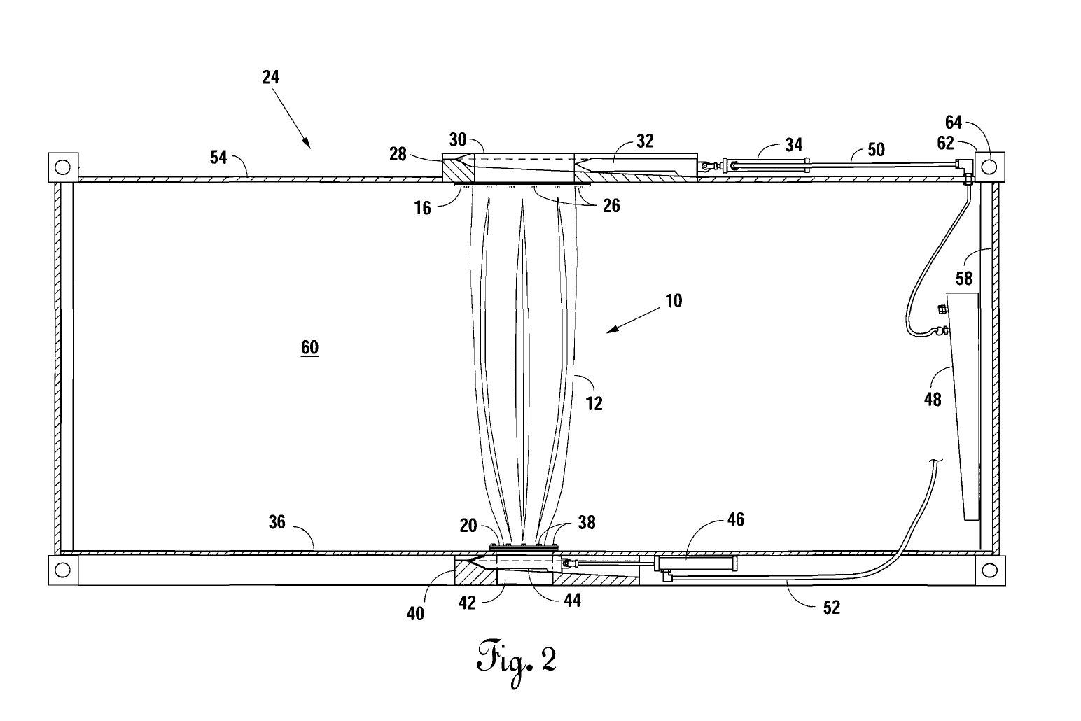

Turning now to FIG. 2, the resilient liner 10 is shown mounted inside of an intermodal container 24. The upper mounting bracket 16 is attached by bolts 26 to upper hatch frame 28 which surround upper hatch 30. Upper sliding gate 32 retained in hatch frame 28 may be opened or closed by upper hydraulic cylinder 34.

The lower end of the resilient liner 10 is attached to the bottom 36 of the intermodal container 24 by means of bolts 38 extending through the mounting holes 22 (see FIG. 1) in the lower mounting bracket 20. The bolts 38 extend into the lower hatch frame 40. The lower hatch frame 40 surrounds lower hatch 42. Inside of lower hatch 42 is a lower sliding gate 44. The lower sliding gate 44 is operated by lower hydraulic cylinder 46.

Operation of the upper hydraulic cylinder 34 and the lower hydraulic cylinder 46 is controlled by control box 48 which controls the hydraulic fluid flowing through upper hydraulic line 50 to upper hydraulic cylinder 34, or through lower hydraulic line 52 to lower hydraulic cylinder 46, respectively. While the control box 48 is shown inside intermodal container 29, the control box 48 may be located on one end so it is accessible from the outside.

The intermodal container 24 is of the standard type having a bottom 36, top 54, left end 56, right end 58 and far side 60. The near side (not shown) has been cut away for illustration purposes. At each of the corners are located corner castings 62 with opening 64 for twist-lock fasteners (not shown).

In operation, the upper sliding gate 32 is opened by upper hydraulic cylinder 34 so that a proppant such as sand may flow through the upper hatch 30 into the resilient liner 10. As the proppant comes to rest against the closed lower sliding gate 44, the proppant begins to accumulate in height. The weight of the column of proppant due to its angle of repose will exert an outward force on the resilient liner 10. At a certain point, the bladder 12 of the resilient liner 10 will begin to expand outward as the proppant accumulates and weight thereof increases. By properly sizing of the resilient liner 10 and bladder 12, the proppant can fill the intermodal container 24 with the only vacant area being the angle of repose extending down and out from the upper hatch 30.

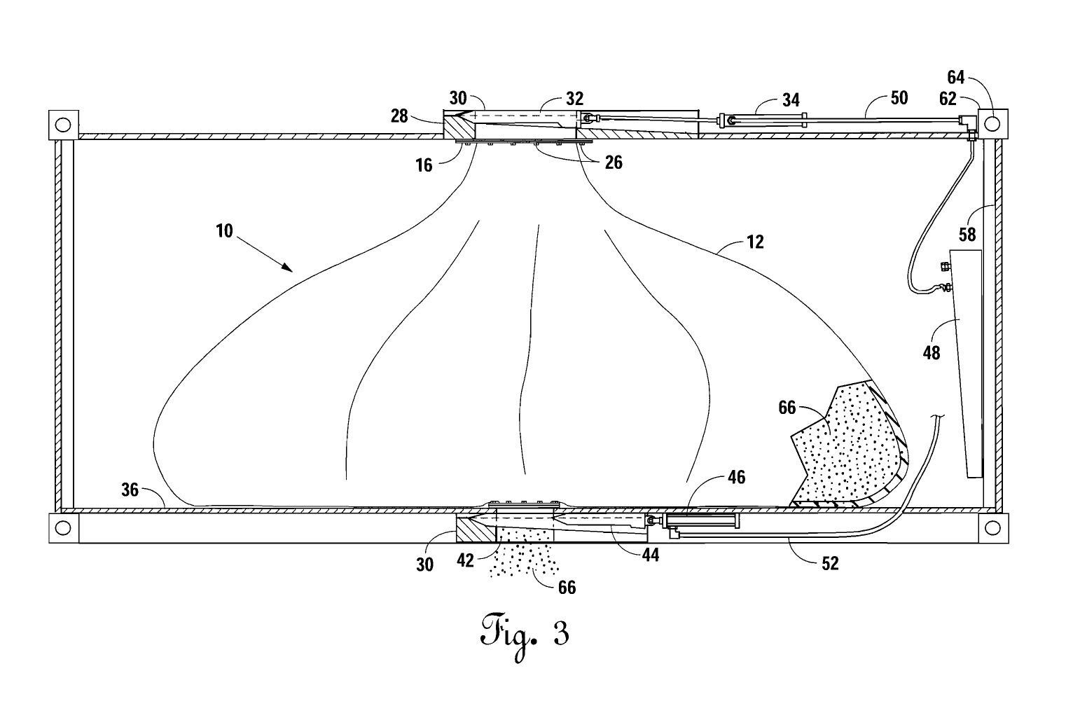

Referring to FIG. 3, the intermodal container 24 previously filled with a proppant 66 is being unloaded. Proppant 66 was previously inserted through the upper hatch 30 into the bladder 12 of the resilient liner 10 and the resilient liner expanded as is pictorially indicated in FIG. 3. After a sufficient amount of proppant 66 has been inserted through upper hatch 30 while the upper sliding gate 32 is open, once the desired amount of proppant 66 is received within the bladder 12, then the sliding gate 32 is closed and the intermodal container 24 is shipped to the desired location.

At the desired location, the upper sliding gate 32 remains closed and the lower sliding gate 44 is opened to allow the proppant 66 to flow through lower hatch 42 as illustrated in FIG. 3. As proppant 66 flows out the lower hatch 42, the resilient nature of the bladder 12 would tend to resume its prior configuration shown in FIG. 2. As the bladder 12 resumes its original configuration as shown in FIG. 2, more and more of the proppant 66 will move towards the middle and flow out through the lower hatch 42. Eventually all of the proppant 66 will be discharged from the intermodal container 24.

Typically, when discharging proppant 66 from the intermodal container as shown in FIG. 3, the proppant may be discharged at any desired location such as into a Sand King (not shown) at a frac site.

The controls 48, which will be accessible outside of the intermodal container 24, may be used to open or close upper sliding gate 32 or lower sliding gate 44, depending upon whether the intermodal container 24 is being filled or emptied.

What I claim is:

1. A modified intermodal container for carrying a proppant from a source to a frac site, the modified intermodal container comprising:
an intermodal container having a top, bottom, front, back, left end and right end;
an upper hatch in said top of said intermodal container with an upper hatch frame there around;
an upper gate for opening and/or closing said upper hatch;
a lower hatch in said bottom of said intermodal container with a lower hatch frame there around;
a lower gate for opening and/or closing said lower hatch;
a resilient liner connecting between said upper hatch frame and said lower hatch frame, said resilient liner expanding to receive said proppant during loading through said upper hatch and retracting to force proppant therefrom during unloading through said lower hatch.

2. The modified intermodal container for carrying proppant to a frac site as recited in claim 1 wherein said resilient liner is a bladder.

3. The modified intermodal container for carrying proppant to a frac site as recited in claim 2 wherein said lower gate is a first sliding gate that is operated remotely.

4. The modified intermodal container for carrying proppant to a frac site as recited in claim 3 wherein said upper gate is a second sliding gate that is operated remotely.

5. The modified intermodal container for carrying proppant to a frac site as recited in claim 2 wherein said bladder is held at said top between an upper portion and a lower portion of an upper mounting bracket and is held to said bottom between an upper portion and a lower portion of said lower mounting bracket.

6. The modified intermodal container for carrying proppant to a frac site as recited in claim 5 wherein said bladder has folds therein to aid in expansion or contraction.

7. A method of modifying an intermodal container to carry granular material such as sand therein; said intermodal container having a top, bottom, sides and ends; said method including the following steps:
cutting an upper hatch in said top and a lower hatch in said bottom;
attaching an upper mounting bracket on an upper end of an elongated bladder and a lower mounting bracket on a lower end of said elongated bladder;
securing an upper gate over said upper hatch and a lower gate over said lower hatch;
fixing said upper mounting bracket around said upper hatch and said lower mounting bracket around said lower hatch so that said bladder extends there between;
said bladder expanding during loading to receive granular material therein through said upper hatch and retracting during unloading to move said granular material toward a middle of said intermodal container and out said lower hatch.

8. The method of modifying an intermodal container to carry granular material as recited in claim 7 wherein said attaching step including clamping said upper end of said bladder between an upper portion and to lower portion of said upper mounting bracket.

9. The method of modifying an intermodal container to carry granular material as recited in claim 8 wherein said attaching step includes clamping said lower end of said bladder between an upper portion and a lower portion of said lower mounting bracket.

10. The method of modifying an intermodal container to carry granular material as recited in claim 7 wherein said elongated bladder is resilient and has folds therein to increase elasticity.

11. The method of modifying an intermodal container to carry granular material as recited in claim 7 including an additional step of installing remote controls for operation of said upper gate and said lower gate.

12. The method of modifying an intermodal container to carry granular material as recited in claim 11 wherein an upper hydraulic cylinder operates said upper gate and a lower hydraulic cylinder operates said lower gate from said remote controls.
